(19) United States
(12) Patent Application Publication
(10) Pub. No.: US 2016/0364497 A1
(43) Pub. Date: Dec. 15, 2016

(54) METHOD AND DEVICE FOR INCREASING THE SPEED OF ONLINE BROWSING AND LOADING OF PDF DOCUMENT

(71) Applicant: BEIJING BRANCH OFFICE OF FOXIT CORPORATION, Beijing (CN)

(72) Inventors: Yuwqian Xiong, Beijing (CN); Fangming Liu, Beijing (CN)

(21) Appl. No.: 15/107,937

(22) PCT Filed: Jul. 22, 2014
(86) PCT No.: PCT/CN2014/000693

§ 371 Date: Aug. 19, 2016

(30) Foreign Application Priority Data
Dec. 27, 2013 (CN) 201310741339.2

(51) Int. Cl. G06F 17/30; H04L 29/06; H04L 29/08

(52) U.S. Cl. CPC G06F 17/30902; G06F 17/30011; G06F 17/30896; H04L 67/02; H04L 67/42

(57) ABSTRACT

A method and device for increasing the online browsing and loading speed of a PDF document, comprising: acquiring attribute information of a PDF document from a remote server, and determining whether the PDF document is a nonlinear document; if yes, then acquiring cross reference table data from the remote server, determining position and size of the page tree of the PDF document according to the cross reference table data, and acquiring the page tree from the remote server; presenting the obtained page tree to a user, analyzing the page data of the page tree, extracting, from the page tree, the position and size of the page object specified by the user, and acquiring corresponding page object data from the remote server; acquiring, from the remote server, resource object data and page content stream data; and acquiring the page selected by the user, and presenting the page.

### FIELD OF THE INVENTION

The present invention relates to the field of network document processing, particularly relates to a method and device for increasing the speed of online browsing and loading of a PDF document.

### BACKGROUND OF THE INVENTION

Portable Document Format (PDF for short) is an electronic document format, which is independent of the operating system platform. Due to its above characteristic, the PDF format becomes the ideal document format for the electronic document distribution and the digital information dissemination on the Internet. More and more e-books, product descriptions, company statements, network information, and e-mails start to use the file in PDF format. when using these information, users do not need to download all the documents, furthermore some documents are not available for download, so we often just need to browse these documents online.

However, at present, if a user wants to open the remote PDF file when browsing the document online, he or she need to download the entire contents of the PDF file to local firstly and then parse and display the PDF file. The browsing speed is limited by the speed of network, usually the external environment are difficult to be changed. The entire time for downloading the PDF file is viewed as the bottleneck to the browsing effect.

### SUMMARY

The present invention aims to provide a solution, which can display part contents of a PDF file to the user once the part contents is downloaded, of waiting all the contents of the entire file is downloaded completely, so that the speed of online browsing and loading the PDF document is improved.

In order to reach the above goal, the present invention provides a device for increasing the speed of online browsing and loading the PDF document, the device comprising:

a judgment module, used for acquiring the attribute information of the PDF document from a remote server, and judging whether the PDF document is a nonlinear document according to the attribute information;

a page tree module, used for invoking the download module to acquire the cross reference table data of the PDF document from the remote server determining the position and size of the page tree of the PDF document from the position and size of each object in the cross reference table data, and thereby according to the determined position and size of the page tree, invoking the download module to acquire the page tree of the PDF document from the remote server when the PDF document is a nonlinear document;

a page object module, used for analyzing the page data of the page tree, extracting the position and size of the page object specified by the user from the page tree, and invoking the download module to acquire the corresponding page object data from the remote server according to the position and size of the page object;

a resource object and page content stream module, invoking the download module to acquire resource object data and page content stream data corresponding to the acquired page object data from the remote server;

a document display module, used for acquiring the page selected by the user according to the acquired page object data, resource object data and page content stream data, and presenting the page to the user;

the download module, used for downloading related data from the remote server according to the invoking commands of the page tree module, the page object module, the resource object and page content stream module.

Wherein, the above device further comprises:

an interactive form module, when the page object specified by the user comprises a interactive form, the interactive form module is used for acquiring the position and size of all the related objects specified in the acquired interactive form of the PDF document, invoking the download module to acquire corresponding table data from the remote server according to the position and size of the all the related objects specified in the extracted interactive form, and presenting the table data to the user, and receiving the interactive form operation by the user.

Therein, the page object module is also used for invoking the download module to download the entire PDF document and then presenting it to the user, when it fails to acquire the page tree or fails to analysis the page data to the page tree.

Wherein, the judgment module is also used for invoking the download module to directly download the content on page 1 of the PDF document and presenting it the user when judging the PDF document is a linear document, then performing the follow pages in the nonlinear file way, and presenting the acquired page to the user, wherein the content on page 1 of the linear file is at the beginning of the PDF document.

The present invention further provides a method for increasing the speed of online browsing and loading of the PDF document, the method comprising the following steps:

Acquiring the attribute information of the PDF document from a remote server, and judging whether the PDF document is a nonlinear document according to the attribute information;

if the PDF document is a nonlinear document, acquiring the cross reference table data of the PDF document from a remote server, determining the position and size of the page tree of the PDF document according to the position and size of each object in the cross reference table data, and acquiring the page tree of the PDF document from the remote server according to the determined position and size of the page tree;

presenting the acquired page tree to the user, receiving the page selected in the page tree by the user, analyzing the page data of the page tree, extracting the position and size of the page object specified by the user from the page tree, and acquiring the corresponding page object data from the remote server according to the position and size of the page object;

Acquiring resource object data and page content stream data corresponding to the acquired page object data from the remote server;

acquiring the page selected by the user and presenting it to the user according to the acquired page object data, the resource object data and the page content stream data.

The above method further comprises the following steps:

when the page object specified by the user comprises the interactive form, acquiring the position and size of all the related objects specified in the interactive form from the PDF document, and acquiring the corresponding table data from the remote server according to the extracted position and size of the all the related objects specified in the interactive form, and presenting the table data to the user, and receiving the interactive form operation by the user.

Wherein, the entire PDF document is downloaded and presented to the user when it fails to acquire the page tree or fails to analysis the page data to the page tree.

Wherein, if the PDF document is a linear document, the content on page 1 of the PDF document is directly downloaded and presented to the user, then the follow pages are performed in the nonlinear file way, and the acquired pages are presented to the user, wherein the content on page 1 of the linear file is at the beginning of the PDF document.

Compared with the prior art, the beneficial effect of the present invention is:

The present invention provides a method and device for increasing the speed of online browsing and loading of the PDF document, it is supported that the page is specified by the user via the cross reference table and page tree, it only need to download part of the contents of a PDF file and display it to the user, rather than waiting all the contents of the entire file is downloaded, it can reduce the waiting time for users, increase the online browsing and loading speed of the PDF document, so that to reach the goal of fast browsing the PDF page.

### BRIEF DESCRIPTION OF DRAWINGS

In order to illustrate the technical solutions in the embodiments of the present invention or in the prior art more clearly, the drawings needed to be used in the description of the embodiments will be simply introduced below. Apparently, the following description of the drawings are only some embodiments in the present invention, but for a person skilled in the art, other drawings can also be acquired on the basis of the drawings, without exercising any inventive skill.

FIG. 1 is a block diagram of a device for increasing the speed of online browsing and loading of the PDF document in an embodiment of the present invention.

FIG. 2 is a flow diagram of a method for increasing the speed of online browsing and loading of the PDF document in an embodiment of the present invention.

### DETAILED DESCRIPTION OF THE EMBODIMENTS

The technical solutions in the embodiments of the present invention will be clearly and entirely described referring to the accompanying drawings in the embodiments of the present invention. It is clear that the described embodiments are merely part of the embodiments of the present invention, but not all embodiments. All the other embodiments which a person skilled would acquire on the basis of the embodiments of the present invention, without exercising any inventive skill, are within the protection scope of the present invention.

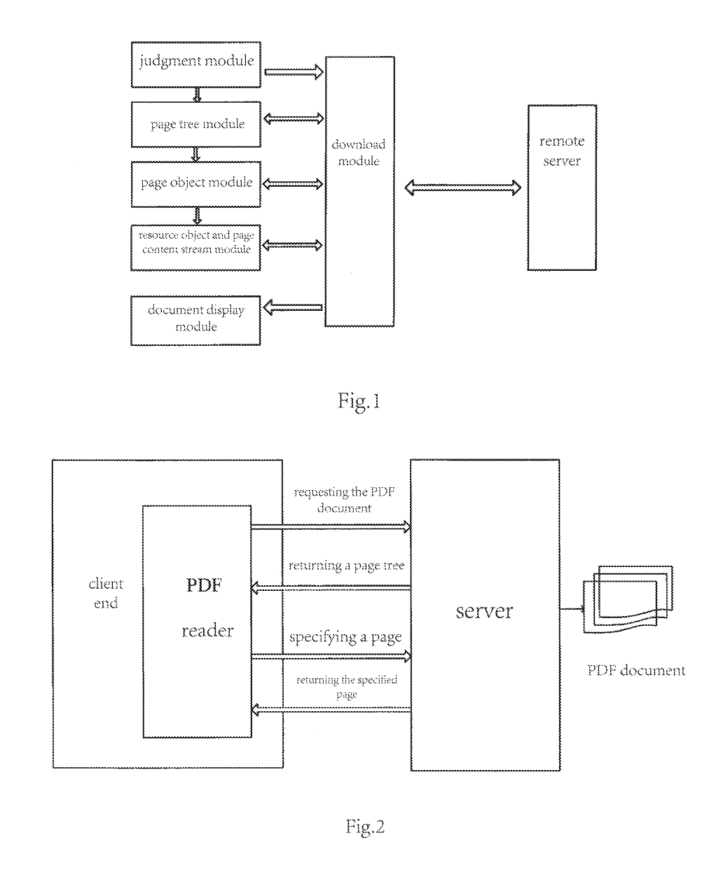

Referring to FIG. 1, FIG. 1 is a block diagram of a device for increasing the speed of online browsing and loading of the PDF document in an embodiment of the present invention. As shown in FIG. 1, the present invention also provides a device for increasing the speed of online browsing and loading of the PDF document in an embodiment of the present invention, the device comprising:

a judgment module, used for acquiring the attribute information of the PDF document from a remote server, and judging according to the attribute information whether the PDF document is a nonlinear document; wherein the attribute information refers to in the PDF document the position and length of the linearization data stored at the beginning of the PDF document (within the first 1024 bytes);

a page tree module, when the PDF document is a nonlinear document, it used for invoking the download module to acquire the cross reference table data of the PDF document from the remote server, determining the position and size of the page tree of the PDF document according to the position and size of each object in the cross reference table data, and thereby according to the determined position and size of the page tree, invoking the download module to acquire the page tree of the PDF document from the remote server; wherein, the Cross-reference Table refers to a indirect object address index table , which is established to randomly access the indirect object; the indirect object form the specific content of the PDF document, such as typefaces, pages, images and so on; the address of the Cross-reference Table is declared at the Trailer; The page tree, the Outline Tree, the article Threads and the Named Destination are four sub-trees in the Catalog of the PDF document, which reflect the hierarchy level relationships of the PDF document, control the entire PDF document according to the Catalog provided at the trailer, and in the present invention, the page object is acquired by the page tree;

a page object module, used for analyzing the page data of the page tree, extracting, from the page tree, the position and size of the page object specified by the user, and according to the position and size of the page object, invoking the download module to acquire the corresponding page object data from the remote server;

a resource object and page content stream module, invoking the download module to acquire resource object data and page content stream data corresponding to the acquired page object data from the remote server; wherein, the content stream refers to the number, character strings, images and so on; the resource object refers to all the resources used in the content stream, such as ProcSet, Font, Color space, Pattern and so on;

a document display module, used for acquiring the page selected by the user according to the acquired page object data, resource object data and page content stream data, and presenting the page to the user;

the download module, used for downloading the related data from the remote server according to the invoking commands of the page tree module, the page object module, the resource object and page content stream module.

In the embodiment, the device further comprises:

an interactive form module, when the page object specified by the user comprises the interactive form item, it used for acquiring the position and size of all the related objects specified in the interactive form item, invoking the download module to acquire the corresponding table data from the remote server according to the extracted position and size of the all the related objects specified in the interactive form item, and presenting the page to the user, and receiving the operation of the interactive form item by the user.

In the embodiment, the page object module is also used for invoking the download module to download the entire PDF document, and then displaying the entire PDF document to the user, when it fails to acquire the page tree or fails to analysis the page data on the page tree.

In the embodiment, the determination module is also used for invoking the download module to directly download the content on page 1 of the PDF document if the PDF document is judged as a linear document, and presenting the content to the user, then the follow pages are performed in the linear file way, and the acquired pages are presented to the user, wherein the content on page 1 of the linear file is at the beginning of the PDF document.

Referring to FIG. 2, FIG. 2 is a flow diagram of a method for increasing speed of the online browsing and loading of the PDF document in an embodiment of the present invention. As shown in FIG. 2, the present invention also provides a method for increasing speed of the online browsing and loading of the PDF document, the method comprising:

Acquiring the attribute information of the PDF document from a remote server, and judging whether the PDF document is a nonlinear document according to the attribute information;

if the PDF document is a nonlinear document, acquiring the cross reference table data of the PDF document from the remote server, determining the position and size of the page tree of the PDF document according to the position and size of each object in the cross reference table data, and according to the determined position and size of the page tree, acquiring the page tree of the PDF document from the remote server;

presenting the acquired page tree to the user, receiving the page selected by the user in the page tree, analyzing the page data of the page tree, extracting, from the page tree, the position and size of the page object specified by the user, and according to the position and size of the page object, acquiring the corresponding page object data from the remote server;

acquiring resource object data and page content stream data corresponding to the acquired page object data from the remote server;

According to the acquired page object data, the resource object data and the page content stream data, acquiring the page selected by the user, and presenting the page to the user.

In the embodiment, the method further comprises the following steps:

when the page object specified by the user comprises the interactive form item, acquiring the position and size of all the related objects specified in the interactive form item from the PDF document, and acquiring the corresponding table data from the remote server according to the extracted position and size of the all the related objects specified in the interactive form item, and presenting the page to the user, and receiving the interactive form operation by the user.

In the embodiment, the entire PDF document is downloaded, and then the page is presented to the user, when the page tree is failure to acquire or when the page data analysis on the page tree is failed.

In the embodiment, if the PDF document is a linear document, the content on page 1 of the PDF document is directly downloaded, and the content is presented to the user, then the follow pages are performed in the linear file way, and the acquired pages are presented to the user, wherein the content on page 1 of the linear file is at the beginning of the PDF document.

For a person skilled in the art, it should be understood that: the drawings are only schematic diagrams of an embodiment, and the modules or process or data in the drawings are not necessarily needed to implement the present invention.

Finally, it should be noted that: the above embodiments are merely provided to illustrate the technical solutions of the present invention, but not intended to limit them; Although the present invention has been described in detail referring to the above embodiments, for a person skilled in the art, it should be understood that: the technical solutions recorded in the foregoing embodiments can be modified or part of the technical characteristics thereof can be replaced by the equivalent; but the modifications or replacements do not make the essence of the corresponding technical solutions depart from the spirit and scope of technical solutions in the embodiments of the present invention.

1. A device for increasing the speed of online browsing and loading of the PDF document, wherein, the device comprising:
a judgment module, used for acquiring the attribute information of the PDF document from a remote server, and judging whether the PDF document is a nonlinear document according to the attribute information;
a page tree module, used for invoking the download module to acquire the cross reference table data of the PDF document from the remote server, determining the position and size of the page tree of the PDF document from the position and size of each object in the cross reference table data, and thereby invoking the download module to acquire the page tree of the PDF document from the remote server according to the determined position and size of the page tree when the PDF document is a nonlinear document;
a page object module, used for analyzing the page data of the page tree, extracting the position and size of the page object specified by the user from the page tree, and invoking the download module to acquire the corresponding page object data from the remote server according to the position and size of the page object;
a resource object and page content stream module, used for invoking the download module to acquire resource object data and page content stream data corresponding to the acquired page object data from the remote server;
a document display module, used for acquiring the page selected by the user according to the acquired page object data, resource object data and page content stream data, and presenting the page to the user;
the download module, used for downloading related data from the remote Server according to the invoking commands of the page tree module, the page object module, the resource object and page content stream module.

2. The device for increasing the speed of online browsing and loading of the PDF document according to claim 1, wherein the device further comprising:
an interactive form module, used for acquiring the position and size of all the related objects specified in the interactive form of the PDF document when the page object specified by the user comprising the interactive form, and invoking the download module to acquire corresponding table data from the remote server according to the position and size of the all the related objects specified in the extracted interactive form, and presenting the table data to the user, and receiving the interactive form operation of the user.

3. The device for increasing the speed of online browsing and loading of the PDF document according to claim 1, wherein the page object module is also used for invoking the download module to download the entire PDF document and then presenting it to the user when there is a fail in acquiring the page tree or there is a fail in analyzing the page data to the page tree.

4. The device for increasing the speed of online browsing and loading the PDF document according to claim 1, wherein, the judgment module is also used for invoking the download module to directly download the content on page 1 of the PDF document and presenting it to the user when the PDF document is judged as a linear document, then treating the following pages in the nonlinear file way, and presenting the thema to the user, wherein the content on page 1 of the linear file is at the beginning of the PDF document.

5. A method for increasing the speed of online browsing and loading speed of the PDF document, wherein the method comprising the following steps:
acquiring the attribute information of the PDF document from a remote server, and judging whether the PDF document is a nonlinear document according to the attribute information;
if the PDF document is a nonlinear document, acquiring the cross reference table data of the PDF document from a remote server, determining the position and size of the page tree of the PDF document according to the position and size of each object in the cross reference table data, and acquiring the page tree of the PDF document from the remote server according to the determined position and size of the page tree;
presenting the acquired page tree to the user, receiving the page selected by the user in the page tree, analyzing the page data of the page tree, extracting the position and size of the page object specified by the user from the page tree, and acquiring the corresponding page object data from the remote server according to the position and size of the page object;
acquiring resource object data and page content stream data corresponding to the acquired page object data from the remote server;
according to the acquired page object data, the resource object data and the page content stream data, acquiring the page selected by the user and presenting the page to the user.

6. The method for increasing the speed of online browsing and loading of the PDF document according to claim 5, wherein the method further comprising the following steps:
when the page object specified by the user comprising the interactive form, acquiring the positions and sizes of all the related objects specified in the interactive form from the PDF document, and acquiring the corresponding table data from the remote server according to the extracted position and size of the all the related objects specified in the interactive form, and presenting it to the user, and receiving the interactive form operation of the user.

7. The method for increasing speed of the online browsing and loading of the PDF document according to claim 5, wherein, downloading the entire PDF document and presenting it to the user when there is a fail in acquiring the page tree or there is a fail in analyzing the page data of the page tree.

8. The method for increasing speed of the online browsing and loading of the PDF document according to claim 5, wherein, downloading the content on page 1 of the PDF document directly, if the PDF document is a linear document, and presenting it to the user, then treating the following pages in the nonlinear file way, and acquiring them to the user, wherein the content on page 1 of the linear file is at the beginning of the PDF document.
